(19) United States
(12) Patent Application Publication
(10) Pub. No.: US 2018/0330386 A1
(43) Pub. Date: Nov. 15, 2018

(54) PROOF OF OWNERSHIP DEVICE AND METHODS FOR USING THE SAME

(71) Applicant: Heonsu Kim, San Jose, CA (US)

(72) Inventor: Heonsu Kim, San Jose, CA (US)

(21) Appl. No.: 15/590,971

(22) Filed: May 9, 2017

(51) Int. Cl. G06Q 30/00; G06F 13/42; H04L 29/06

(52) U.S. Cl. CPC G06Q 30/0185; G06F 13/4282; H04L 63/0823; H04L 63/0435; H04L 63/061; H04L 63/0442

(57) ABSTRACT

Methods and apparatuses are provided for a proof of ownership device and methods for using the same. In one embodiment, a proof of ownership device includes a transceiver configured to wirelessly communicate with an authentication server, a memory configured to store information about an authentic product made by a manufacturer, a battery configured to provide power to the proof of ownership device, and a controller configured to pair the proof of ownership device to the authentic product and control a status update of the authentic product.

### FIELD

The present invention relates to the field of product authentication, in particular, the present invention relates to as proof of ownership device and methods tm using the same.

### BACKGROUND

With advancement in manufacturing technology, it has become easier to make replica products through skilled workmanship and computer numerical control machine. Although selling and buying a counterfeit product is illegal, there is still abundance of counterfeit products that flooded the marketplace. It is hard to distinguish such counterfeit products from authentic products. Some people hesitate to buy used products because they are not certain whether the products are authentic or counterfeit. These counterfeit products undermine product innovation and hinder healthy economic growth.

Therefore, there is a need to certify authentic products from original manufacturers, such that the manufacturers can avoid incurring damages caused by the counterfeit products and buyers can purchase authentic products without worry.

### SUMMARY

Methods and apparatuses are provided for a proof of ownership device and methods for using the same. In one embodiment, the proof of ownership device includes a transceiver configured to wirelessly communicate with an authentication server, a memory configured to store information about authentic product made by a manufacturer, a battery configured to provide power to the proof of ownership device, and a controller configured to pair the proof of ownership device to the authentic product and control the status update of the authentic product.

According to aspects of the present disclosure, the proof of ownership device may further include a LED configured to indicate the status of the proof of ownership device, and a power management circuit configured to control power usage of the proof of ownership device. The proof of ownership device may further include a USB interface configured to communicate with a linked user device or configured to charge the battery.

The controller may include an encryption engine configured to encrypt an encrypted serial number and information of the authentic product, a plurality of I/O interfaces configured to communicate with peripherals, radio frequency transceiver configured to communicate with the linked user device or other proof of ownership device wirelessly, and a processor configured to compute data for authentication and control operations of the proof of ownership device.

The encryption engine may include a secured hash engine configured to compute a hash value based on the data elements which are the encrypted serial number of the authentic product, ID number of the proof of ownership device and transaction record, and an elliptic curve digital signature engine configured to generate a digital signature based on the inputs received a hash value from the secure hash engine, the private key, and a number from the random number generator. This digital signature can be verified by corresponding public key in authentication server.

According to aspects of the present disclosure, the transceiver is configured to wirelessly communicate with the authentication server via a linked user device, wherein the linked user device comprises at least one of: a smartphone, a tablet, or a personal computer. The memory is configured to store private keys, public keys, certificate/or certificates, an encrypted serial number of the authentic product, identification number of the proof of ownership device, transaction record of the authentic product, and the hash values. The transaction records include a series of chained records showing events of prior activities related to the authentic product.

The controller may be further configured to receive a request (also referred to as a challenge) a digital signature from the authentication server, generate the digital signature using a current record of the authentic product along with a hash value, a private key, and a random number, send the digital signature to the authentication server for verification, and receive a confirmation of the digital signature from the authentication server.

In some implementations, the proof of ownership device may be implemented in the form of at least one of: a wearable electronic smart watch, where the wearable electronic smart watch is configured to display a logo of the authentic product; a wearable electronic smart wrist band, where the wearable electronic smart wrist band is configured to display the logo of the authentic product; an electronic device with a display, where the electronic device with the display is configured to display the logo of the authentic product; or an electronic device configured to be physically attachable to a wearable item. In implementations where the electronic device is configured to be physically attachable to the authentic product, the controller may be further configured to monitor an acoustic beat noise of the authentic product, determine whether the acoustic beat noise of the authentic product is within a specification of the authentic product, and notify an owner of the authentic product to bring the authentic product for service in response to the acoustic beat noise of the authentic product falls outside the manufacturer specification.

In some implementations, upon verifying the proof of ownership device is paired with the authentic product, the proof of ownership device may be configured to be linked with a wearable device, where the wearable device is configured to display the logo of the authentic product. The proof of ownership device may be linked with the wearable device via a smartphone, a tablet, or, a personal computer.

### BRIEF DESCRIPTION OF THE DRAWINGS

The aforementioned features and advantages of the disclosure, as well as additional features and advantages thereof will be more clearly understandable after reading detailed descriptions of embodiments of the disclosure in conjunction with the non-limiting and non-exhaustive aspects of following drawings. Like numbers are used throughout the figures.

FIG. 1A illustrates an exemplary system that includes a proof of ownership device according to aspects of the present disclosure.

FIG. 1B illustrates exemplary forms of a proof of ownership device according to aspects of the present disclosure.

FIG. 2 illustrates an exemplary implementation of a proof of ownership device according to aspects of the present disclosure.

FIG. 3 illustrates an exemplary implementation of a controller of the proof of ownership device of FIG. 2 according to aspects of the present disclosure.

FIG. 4 illustrates an exemplary implementation of an authentication module of FIG. 3 according to aspects of the present disclosure.

FIG. 5A illustrates an exemplary application environment according to aspects of the present disclosure; FIG. 5B illustrates another exemplary application environment according to aspects of the present disclosure; FIG. 5C illustrates yet another exemplary application environment according to aspects of the present disclosure; FIG. 5D illustrates yet another exemplary application environment according to aspects of the present disclosure, FIG. 5E illustrates yet another exemplary application environment according to aspects of the present disclosure.

FIG. 6 illustrates a method for maintaining a record of an authentic product according to aspects of the present disclosure.

FIG. 7A and FIG. 7B illustrate methods for initialization of the proof of ownership device according to aspects of the present disclosure.

FIG. 8A and FIG. 8B illustrate a method of authenticating the proof of ownership device according to aspects of the present disclosure.

FIG. 9 illustrates additional explanation on the method of verifying a proof of ownership according to aspects of the present disclosure.

FIG. 10 illustrates exemplary methods of attaching a proof of ownership device to a product according to aspects of the present disclosure.

FIG. 11 illustrates an exemplary method of using GPS data to enhance the service of the authentic product according to aspects of the present disclosure.

FIG. 12A illustrates an exemplary application of a proof of ownership device according to aspects of the present disclosure; FIG. 12B illustrates exemplary waveforms recorded by a proof of ownership device according to aspects of the present disclosure.

### DESCRIPTION OF EMBODIMENTS

Methods and apparatuses are provided for a proof of ownership device and methods for using the same. The following descriptions are presented to enable any person skilled in the art to make and use the disclosure. Descriptions of specific embodiments and applications are provided only as examples. Various modifications and combinations of the examples described herein will be readily apparent to those skilled in the art, and the general principles defined herein may be applied to other examples and applications without departing from the scope of the disclosure. Thus, the present disclosure is not intended to be limited to the examples described and shown, but is to be accorded the scope consistent with the principles and features disclosed herein. The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

Some portions of the detailed description that follows are presented in terms of flowcharts, logic blocks, and other symbolic representations of operations on information that can be performed on a computer system. A procedure, computer-executed step, logic block, process, etc., is here conceived to be a self-consistent sequence of one or more steps or instructions leading to a desired result. The steps are those utilizing physical manipulations of physical quantities. These quantities can take the form of electrical, magnetic, or radio signals capable of being stored, transferred, combined, compared, and otherwise manipulated in a computer system. These signals may be referred to at times as bits, values, elements, symbols, characters, terms, numbers, or the like. Each step may be performed by hardware, software, firmware, or combinations thereof.

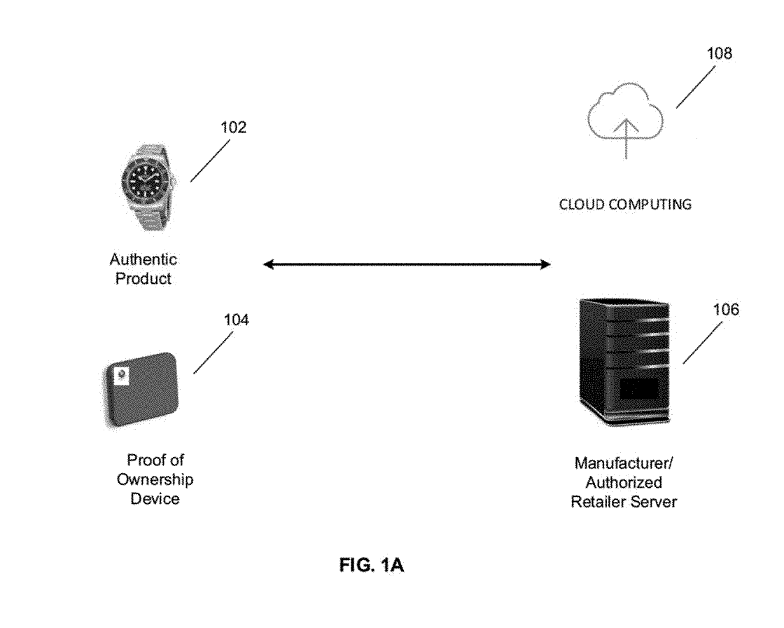

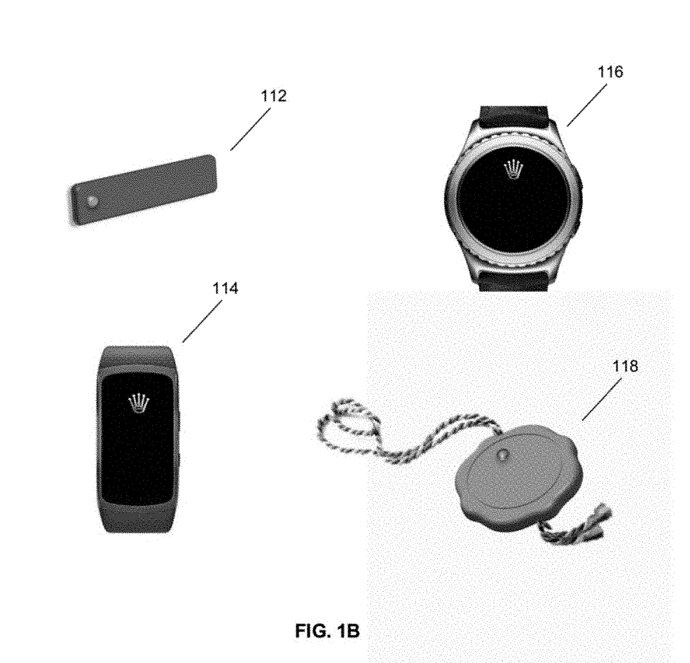

FIG. 1A illustrates an exemplary system that includes a proof of ownership device according to aspects of the present disclosure. As shown in FIG. 1A, the exemplary system includes an authentic product 102, a proof of ownership device 104, and a manufacturer or authorized retailer server 106. The proof of ownership device 104 communicates with the manufacturer or authorized retailer server 106 over the internet.

The authentic product 102, in this case a high-valued watch, may have an associated serial number, reference number, and/or other unique identification. Note that the associated serial number, reference number, and/or other unique identification of the authentic product 102 may be presented in the form of a warranty card or may be marked of in the authentic product 102. The proof of ownership device 104 is a device to prove authentic product with the associated information of the product 102 through cryptography.

As illustrated in FIG. 1A, the proof of ownership device 104 may communicate with a local communication network, such as a personal area network or other effective wired or wireless communications network. More particularly, the proof of ownership device 104 may send data to or receive data from the manufacturer or authorized retailer server 106 through wired or wireless means, such as Bluetooth, 2.4 GHz RF, ANT or USB wired connection.

In some embodiments, the proof of ownership device 104 may communicate with the manufacturer or authorized retailer server 106 through a desktop computer, a notebook computer, a Tablet PC, and/or Smartphone. Note that an operation system or the like is only an example of one suitable operating system or environment to describe the proof of ownership device 104 and its related technology, and not intended to suggest any limitation as to the scope of use or functionality of the technology.

According to this technology, the proof of ownership device 104 may be placed with or without the authentic product 102, and more particularly may be placed in or on the authentic product 102, or may be placed separately from the authentic product 102.

FIG. 1 illustrates exemplary forms of a proof of ownership device according to aspects of the present disclosure. In some exemplary implementations, the proof of ownership device 104 may be manufactured in the form of, including but not limited to: electronic card 112, a wearable smart band 114, a wearable smart watch 116, a tag 118 that may be physically attached to the authentic product 102, or a designer jewelry (not shown).

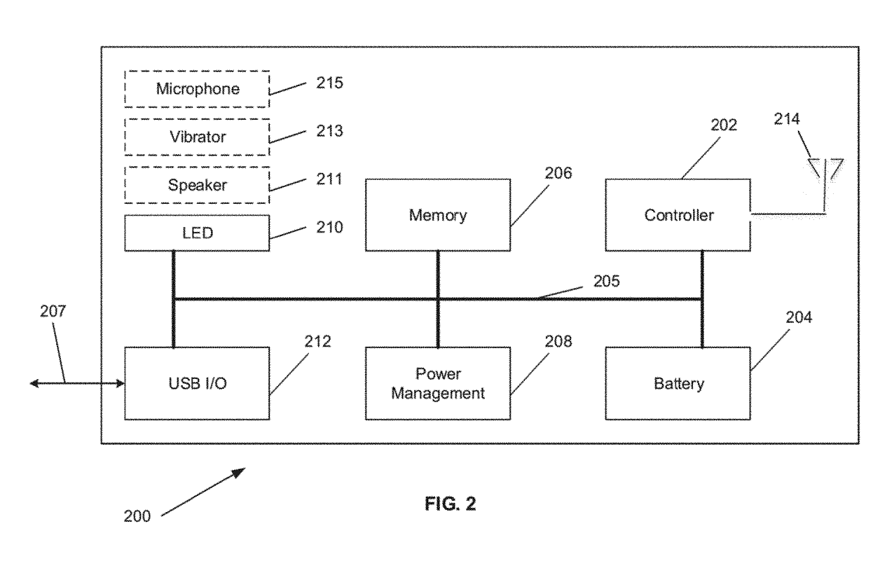

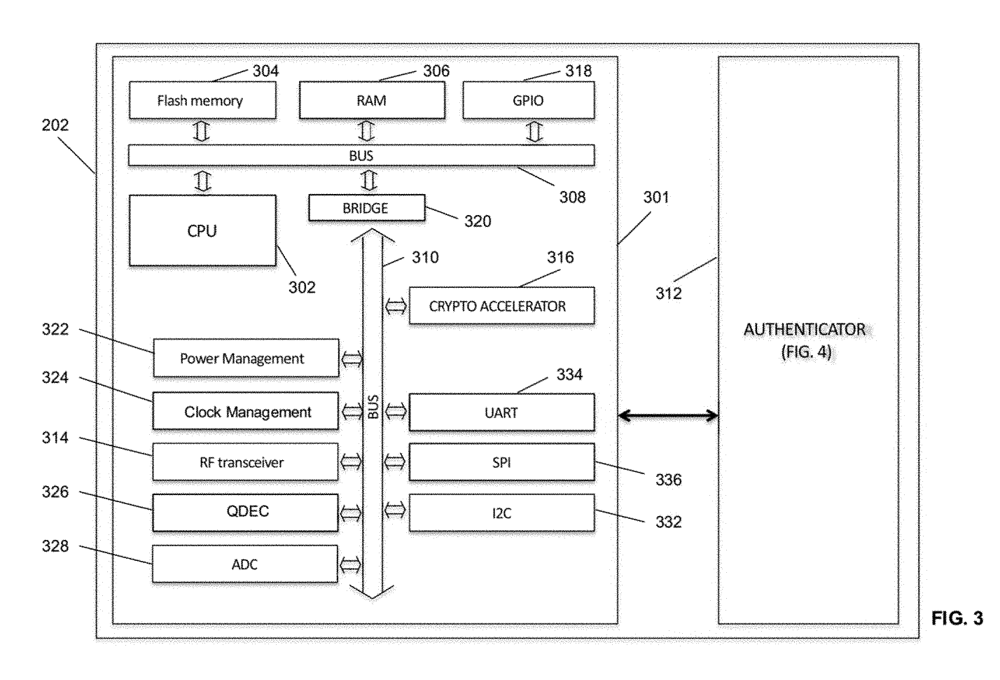

FIG. 2 illustrates an exemplary implementation of a proof of ownership device according to aspects of the present disclosure. In the example shown in FIG. 2, functional components of the proof of ownership device, such as the proof of ownership device shown in FIG. 1A, may include circuitry, hardware and/or firmware components. In one implementation, the proof of ownership device 200 includes a controller 202 configured to control the operations of the proof of ownership device 200, a battery 204 configured to provide power to the proof of ownership device 200, and an external memory 206 configured to store data for the proof of ownership device to prove ownership of authentic, product 200. The proof of ownership device 200 includes a power management circuit 208 configured to regulate input/output voltage and current, to charge battery and to supply power to each components, a LED (light emitting device) 210 configured to indicate various status of the proof of ownership device 200, and a USB I/O 212 configured to supply power to operate the proof of ownership device, to charge the battery 204, and may provide a wired communication 207 between the proof of ownership device 200 and an external device. The components of the proof of ownership device 200 may communicate with each other via a bus 205. In some implementations, the proof of ownership device 200 may optionally include a speaker 211, a vibrator 213, or a microphone 215 configured to perform user interface functions. In some implementations, the memory 206 may reside within the controller 202, which is further described below in association with FIG. 3.

According to aspects of the present disclosure, the LED 210 may be used for notification of device status. Other display devices such, as LCD or OLED can be used instead of LED. For example, when battery power level is low, blinking light or changing color makes user acknowledge the battery status. Also, blinking various light colors indicate the status of operation that may be assigned by user. The controller 202 may include a wireless communication interface, represented by an antenna symbol 214, which performs the function of receiving and/or transmitting wireless communications, such as Bluetooth or other communications with an external device. The wireless communication interface facilitates wireless connectivity between the proof of ownership device 200 and other receivers, transmitters, networks, devices, etc., either via a communication carrier or service provider or via Bluetooth or like communications with other devices.

FIG. 3 illustrates an exemplary implementation of a controller for the proof of ownership device in FIG. 2 according to aspects of the present disclosure. As shown in FIG. 3, the controller may include a general control module 301 and an authenticator 312. The general control module 301 may include one or more central processing unit(s) (CPU) or processor(s) 302, flash memory 304, random access memory (RAM) 306, and general purpose I/O (GPIO) 318. The CPU 302 communicates with Flash memory 304, RAM 306, and GPIO 318 via bus 308. The general control module 301 and the authenticator block 312 may be electrically coupled.

According to aspects of the present disclosure, the CPU 302 may be configured to operate the software and firmware to control various aspects of the proof of ownership device, such as data computation, data transmitting/receiving, data encryption, and data storage. The flash memory 304 is configured to store persistent information that can be retained even if the proof of ownership device has no battery power.

The RF transceiver 314 may be configured to operate in the worldwide ISM frequency, band at 2.400 to 2.4835 GHz. Radio modulation modes and configurable packet structure can enable interoperability with Bluetooth® low energy (BLE).

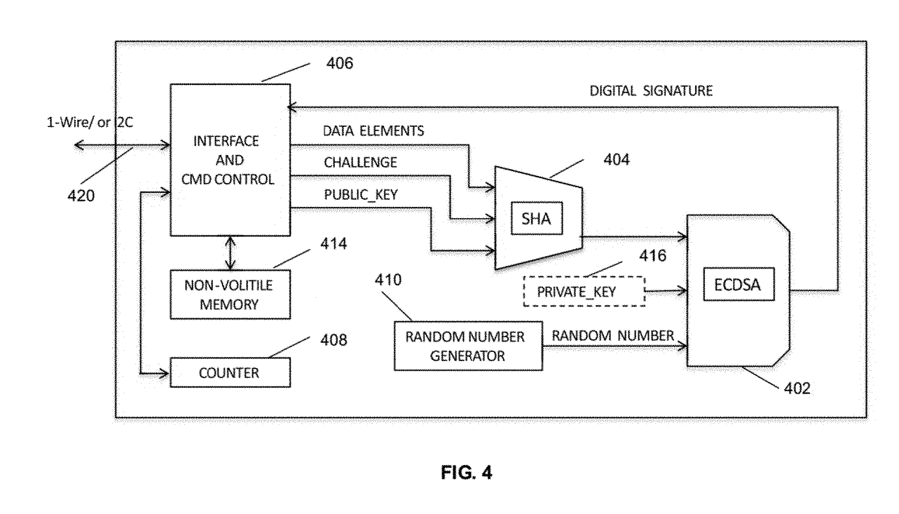

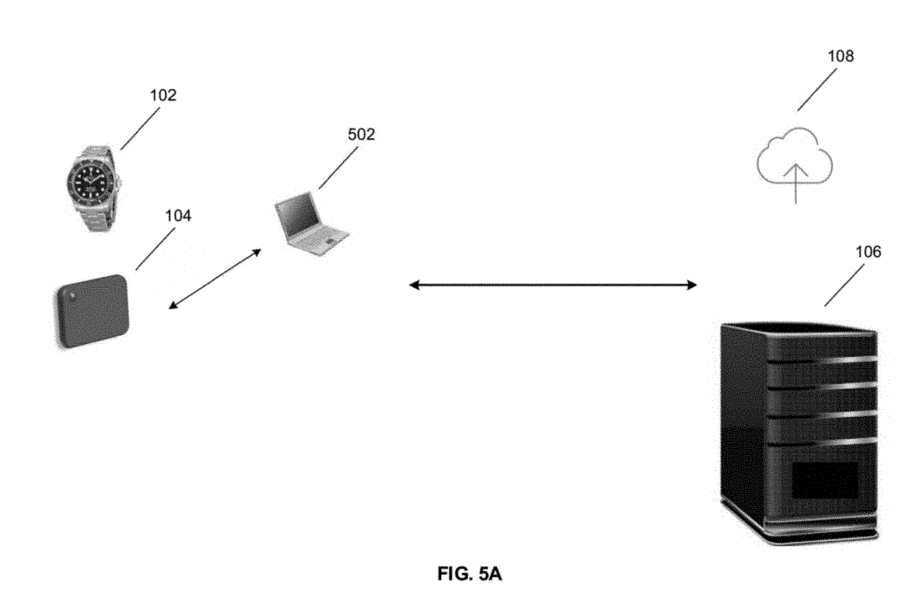

The authenticator 312 may be configured to generate digital signature, which is further described below in association with FIG. 4.

The controller may optionally further include RF transceiver 314, crypto accelerator 316, power management block 322, clock management block 324, QDEC 326, analog to digital converter (ADC) 328, inter-integrated circuit (I2C) 332, universal asynchronous receiver/transmitter (UART) 334, and serial peripheral interface (SPI) 336. In some implementations, the RE transceiver 314, crypto accelerator 316, power management block 322, clock management block 324, QDEC 326, ADC 328, I2C 332. UART 334, and SPI 336 may communicate with the CPU 302 via an optional bridge 320 and an optional bus 310.

The power management block 322 is configured to control power related functions of the controller, including but not limited to: power monitoring, voltage regulation, power-on reset, power brown-out, and etc. The clock management block 324 is configured to control one or more clock(s) within the proof of ownership device. The QDEC 326 is configured to provide buffered decoding of quadrature-encoded sensor signals.

The ADC 328 may be configured to convert an analog signal, such as a sound picked up by a microphone or light entering a digital camera, into a digital signal. The ADC 328 may also provide an isolated measurement such as an electronic device that converts an input analog voltage or current to a digital number proportional to the magnitude of the voltage or current.

The I2C 332 may be a multi-master, multi-slave, single-ended, serial computer bus. It may be used for attaching lower-speed peripheral ICs to processors and microcontrollers in short -distance, intra-board communication such as communication between external memory and controller.

The UART 334 may be configured to conduct asynchronous serial communication in which the data format and transmission speeds are configurable, The UART 334 may be used in conjunction with communication standards such as RS-232, RS422 or RS-485. The UART 334 may be usually an individual (or part of an) integrated circuit block, such as controller 202, used for serial communications over a computer or peripheral device serial port. The UART 334 can be used to communicate with external IC using 1-Wire Bus, 1-Wire Bus using the UART 334 is relatively efficient of small amount of data transmission.

The SPI 336 may be configured to be a synchronous serial communication interface used for short distance communication, primarily in embedded systems, for example to support Secure Digital cards and liquid crystal displays. The SPI 336 may communicate in full duplex mode using master-slave architecture with a single master. The master device originates the frame for reading and writing. Multiple slave devices may be supported through selection with individual slave select (SS) lines.

The GPIO 318 may be configured to be input/output pins for other interface buses, reading, sensors such as IR, temperature, accelerometer or output pins for LC display or LED for status notification.

According to aspects of the present disclosure, the authenticator 312 may be configured to provide a security solution to authenticate product based on public key infrastructure (for example FTPS P-256) based elliptic curve cryptography. The ECDSA engine generates signature using a pseudorandom curve over a prime field according to the “Standards for Efficient Cryptography (SEC)”. The private and public key can be computed within the proof of ownership device or installed by the user and optionally locked. Separate memory space is set aside to store and lock a public-key certificate as it is needed to verify authenticity of the public-key. In addition to ECDSA-related memory, the proof of ownership device has an user memory. Authenticator IC may feature a one-time settable, nonvolatile decrement-on-command counter, which can be used to keep track of the lifetime of the product. The proof of ownership device has its own unique factory assigned Device ID number into the chip. This Device ID number is used as a fundamental input parameter for cryptographic operations.

FIG. 4 illustrates an exemplary implementation of an authenticator module of FIG. 3 according to aspects of the present disclosure. As shown in FIG. 4, the authenticator module 312 may include an ECDSA engine 402, a hash engine (SHA) 404, an interface and command controller 406, a counter 408, a random number generator 410, and a non-volatile memory 414. The authentication module may include its own memory described in FIG. 3 to store device ID, public key certificate, public key and private key. In one exemplary implementation, the interface and command controller 406 may communicate with other circuits via a 1-wire or I2C interface 420. The above components may be logically coupled to each other as shown in FIG. 4.

In some implementations, the authenticator 312 may be configured to use a dedicated cryptosystem for authentication by digital signature using ECDSA engine 402. Also the authenticator 312 may access to non-volatile memory, such as flash memory or EEPROM to compute a hash value of data elements. The authentication module may have its own device identification number stored in the non-volatile memory. This device identification number may be used as a fixed number that can be used to distinguish the proof of ownership device from other devices for the proof of ownership. Note that the ECDSA engine 402 is provided as an example. In other implementations, the authenticator 312 may adopt other cryptosystem such as RSA. Data element such as hash value of previous block data (Genesis block uses encrypted product serial number instead of this previous hash value), ID number of the proof of ownership device, and transaction record is hashed along with challenge data and public key by SHA (secure hash algorithm) engine 406. This encrypted hash value is used for digital signature generation with private-key and random number. The digital signature generated in the proof of ownership device is transmitted to host system (e.g., an authentication server) and verified by public-key device that was pre-generated with private-key. Public-key device may be stored to any device, but private-key device is highly secured and stored only at the proof of ownership device. New key pair, which includes public-key device and private-key device, is generated whenever the proof of ownership device is verified with the authentic product. Server key pair can be generated only by manufacturer or authorized parties.

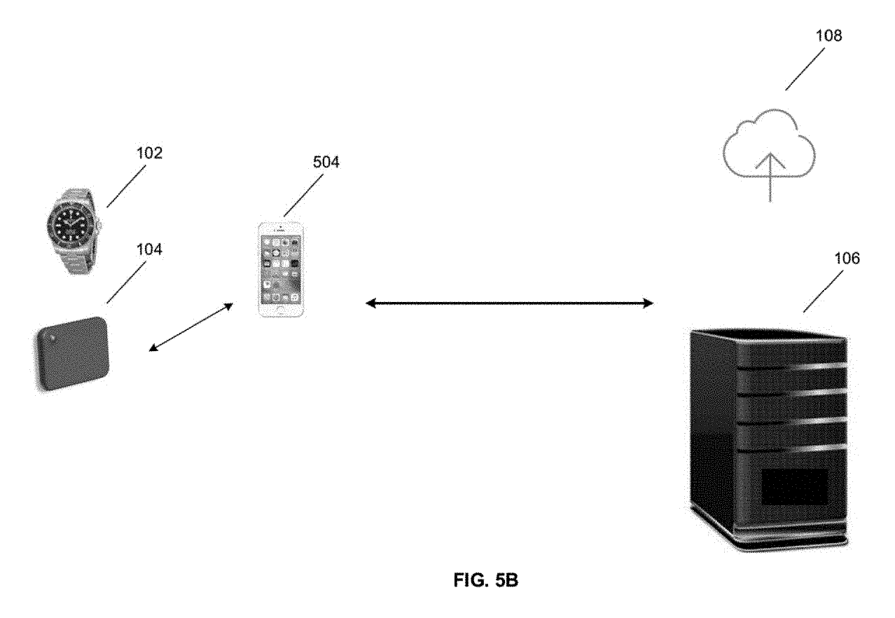

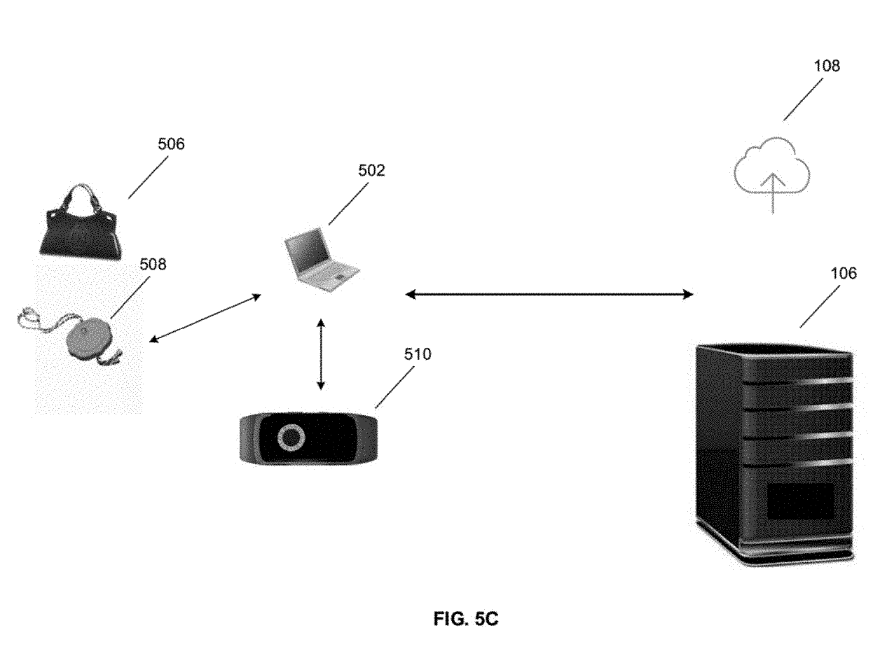

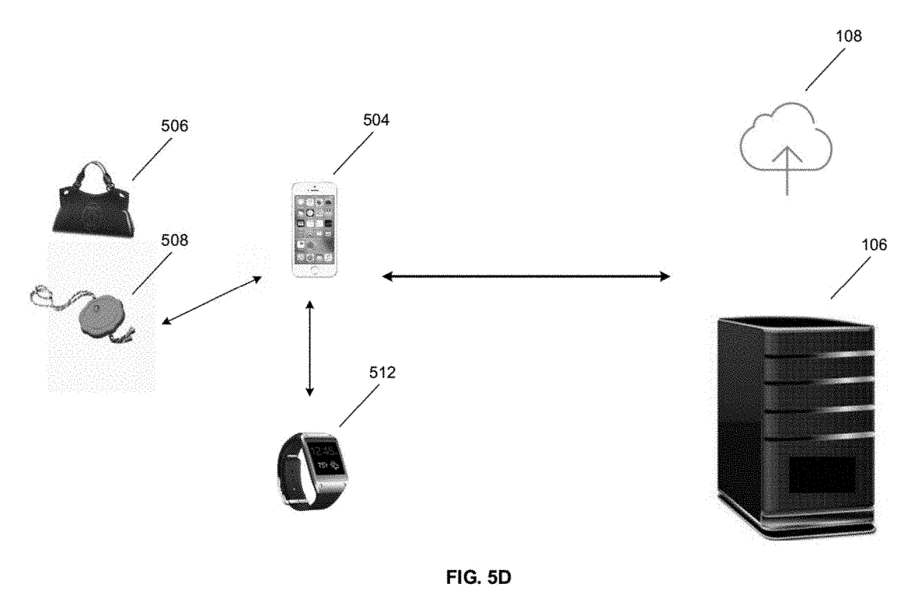

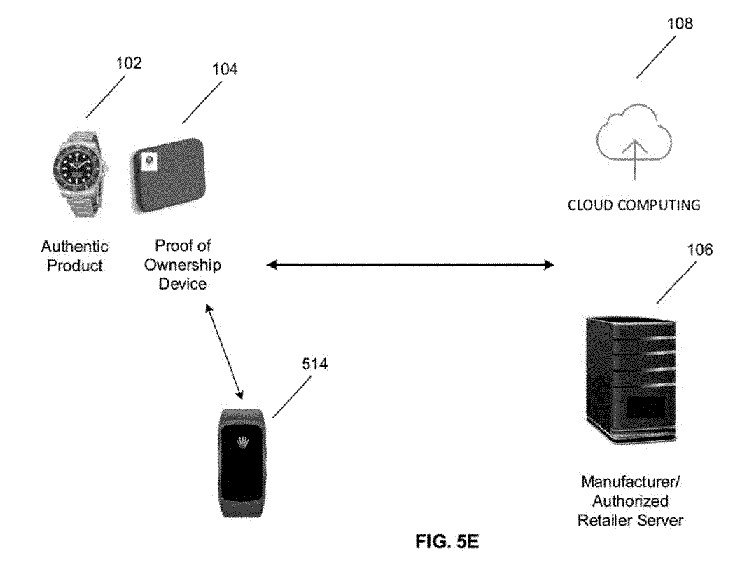

FIG. 5A illustrates an exemplary application environment according to aspects of the present disclosure. Similar to the example shown in FIG. 1A, the exemplary application environment includes an authentic product 102, a proof of ownership device 104, and a manufacturer or authorized retailer server 106. In addition, the exemplary application environment includes a computer 502, also, referred to as, a linked user device. The proof of ownership device 104 communicates with the manufacturer or authorized retailer server 106 in the cloud computing 108 over the internet by the computer 502. The proof of ownership device 104 communicates with the manufacturer or authorized retailer server 106 over the Internet by the computer 502. In this implementation, the computer 502 may download an application software from the manufacturer or authorized retailer website to enable it to communicate with the proof of ownership device 104. The application may also enable the computer 502 to manage updates to the proof of ownership device 104 via authentication server. The proof of ownership device 104 may send data to or receive data from the computer 502 through wired or wireless means, such as Bluetooth, 2.4 GHz RF, ANT or USB wired connection. For security reasons, the proof of ownership device ma receive inputs from authentication server. The computer 502 may function as a data forwarder that transfers data front authentication server to the proof of ownership device. The data communication between the proof of ownership device and authentication server is encrypted and can be decrypted by the proof of ownership device and authentication server.

FIG. 5B illustrates another exemplary application environment according to aspects of the present disclosure. Similar to the example shown in FIG. 5A, the exemplary application environment includes an authentic product 102, the proof of ownership device 104, and a manufacturer or authorized retailer server 106. In addition, the exemplary application environment includes a smartphone 504 or tablet, also referred to as a linked user device. The proof of ownership device 104 communicates with the manufacturer or authorized retailer server 106 over the internet by the smartphone 504. In this implementation, the smartphone 504 may download an application software from the manufacturer or authorized retailer website to enable it to communicate with the proof of ownership device 104. The application software may also enable the smartphone 504 to manage updates to the proof of ownership device 104 via authentication server. The proof of ownership device 104 may send data to or receive data from the smartphone 504 through wired or wireless means, such as Bluetooth, 2.4 GHz RF, ANT or USB wired connection. The smartphone 504 may function as a data forwarder that transfers data from authentication server to the proof of ownership device. The data communication between the proof of ownership device and authentication server is encrypted and can be decrypted by the proof of ownership device and authentication server.

FIG. 5C illustrates yet another exemplary application environment according to aspects of the present disclosure. Similar to the example shown in FIG. 5A, the exemplary application environment includes an authentic product 506, a proof of ownership device 508, and a manufacturer or authorized retailer server 106. In addition, the exemplary application environment includes a computer 502. The proof of ownership device 508 communicates with the manufacturer or authorized retailer server 106 over the internet by the computer 502. In this implementation, the computer 502 may download an application software from the manufacturer or authorized retailer website to enable it to communicate with the proof of ownership device 508. The application software may also enable the computer 502 to manage updates to the proof of ownership device 508 via authentication server. The proof of ownership device 508 may send data to or receive data from the computer 502 through wired or wireless means, such as Bluetooth, 2.4 GHz RF, ANT or USB wired connection. Furthermore, upon verifying the proof of ownership device 508 is paired with the authentic product 506, the computer 502 may link the proof of ownership device 508 with a wearable device 510, for example a smart band. The wearable device 510 may be configured to display a logo of the authentic product 506.

FIG. 5D illustrates yet another exemplary application environment according to aspects of the present disclosure. Similar to the example shown in FIG. 5C, the exemplary application environment includes an authentic product 506, a proof of ownership device 508, and a manufacturer or authorized retailer server 106. In addition, the exemplary application environment includes a smartphone or tablet 504. The proof of ownership device 508 communicates with the manufacturer or authorized retailer server 106 over the internet by the smartphone 504. In this implementation, the smartphone 504 may download an application software from the manufacturer or authorized retailer website to enable it to communicate with the proof of ownership device 508 via authentication server. The application software may also enable the, smartphone 504 to manage updates to the proof of ownership device 508. The proof of ownership device 508 may send data to or receive data from the smartphone 504 through wired or wireless means, such as Bluetooth, 2.4 GHz RF, ANT or USB wired connection. Furthermore, upon verifying the proof of ownership device 508 is paired with the authentic product 506, the smartphone 504 may link the proof of ownership device 508 with a wearable device 512, for example a smart watch. After successfully linking between the proof of ownership device 508 and the wearable device 512, the wearable device 512 may be configured to display a logo of the authentic product 506.

FIG. 5E illustrates yet another exemplary application environment according to aspects of the present disclosure. Similar to the example shown in FIG. 5A, the exemplary application environment includes an authentic product 102, a proof of ownership device 104, and a manufacturer or authorized retailer server 106. The proof of ownership device 104 communicates with the manufacturer or authorized retailer server 106 over the internet. In this implementation, the proof of ownership device 104 may download an application software from the manufacturer or authorized retailer's website 106 to enable communication with a wearable device 514 via authentication server, for example a smart band. Alternatively, the application software may be installed in the proof of ownership device 104 in the factory. The proof of ownership device 104 may send data to or receive data from the wearable device 514 through wired or wireless means, such as Bluetooth, 2.4 GHz RF, ANT or USB wired connection. Furthermore, upon verifying the proof of ownership device 104 is paired with the authentic product 102, the proof of ownership device 104 may link with the wearable device 514. After successful linking between the, proof of ownership device 104 and the wearable device 514, the wearable device 514 may be configured to display a logo of the authentic product 102.

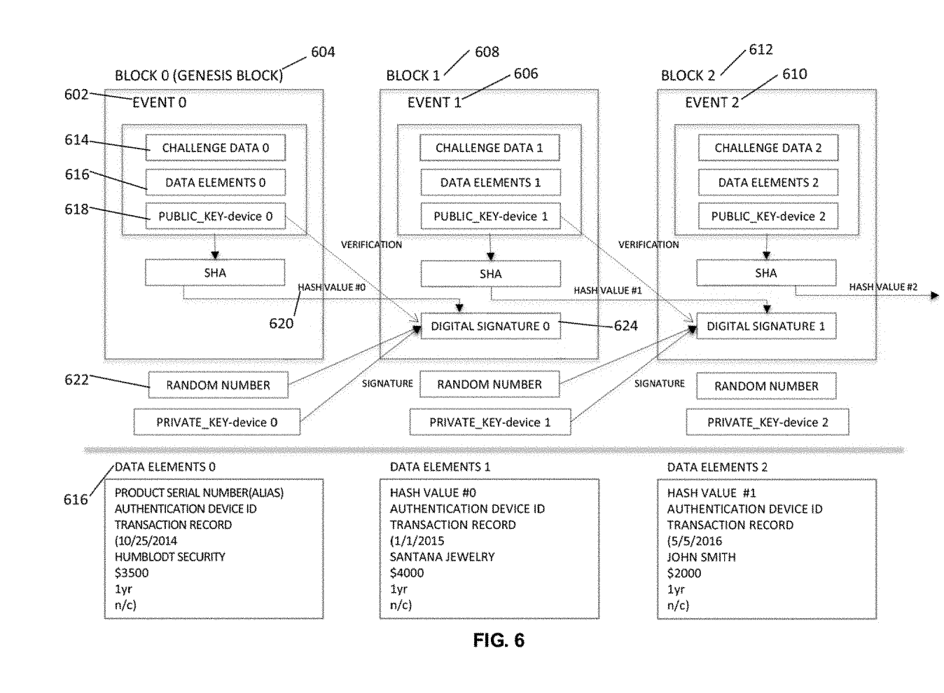

FIG. 6 illustrates a method for maintaining a record of an authentic product according to aspects of the present disclosure. As shown in FIG. 6, each block (also referred to as an event), can be maintained and tracked in the form of a block-chain. For example, Event 0 (602) may be maintained and tracked by Block 0 (604). Similarly, Event 1 (606) may be maintained and tracked by Block 1 (608), Event 2 (610) may be maintained and tracked by Block 2 (612), and so on. New block is generated with the bash value of previous block. Each block is chained consecutively and may be stored in every node such as server(s), linked user device, and the proof of ownership device.

Some implementations, each block may include a challenge data 614, data elements 616, a public key 618, and its corresponding hash value 620. The data elements may include product serial number (only for genesis block, the hash value of previous block is used from EVENT1), ID number of the proof of ownership device, and transaction data, such as date, seller, sale price, warranty duration, etc.

According to aspects of the present disclosure, a digital signature 624 for a subsequent block may be generated using a challenge data 614, data elements 616, public key 618, and its corresponding hash value 620, random number 622, and a private key that is stored in the secured memory in the proof of ownership device. For example, a digital signature for Block 1 may be generated with hash value 620, random number 622, and private key.

According to aspects of the present disclosure, an authentic product may have its own serial number written on itself or in a warranty card and a proof of ownership device may have its own ID number stored in a memory. Both numbers and other information related to the authentic product may be encrypted by SHA to be used to generate digital signature. This digital signature generation can be used to pair the authentic product with the proof of ownership device. If even the ID number of the proof of ownership device has been stolen (or copied), it has already been used for encryption and saved in the proof of ownership device and authentication server. The original serial number cannot be read from the proof of ownership device. To verify whether the serial number is valid or not, a request can be sent to the manufacturer. If the owner of authentic product has the proof of ownership device, authentication server can send a challenge data to the proof of ownership device to assist the proof of ownership device to generate a digital signature for product authentication. As described, this challenge data, along with corresponding data elements and public key are encrypted into a hash value. If data elements in the proof of ownership device are tampered with different transaction records, it can be detected by the hashed value and previous data block may not be chained due to discrepancy of hash values in the transaction. Note that the hash value cannot be computed by irreversible way. Any data changes can result in a different hash value. Other nodes may verify the hash value because block data is stored to other nodes such as server(s), smartphone, notebook pc, and other linked devices.

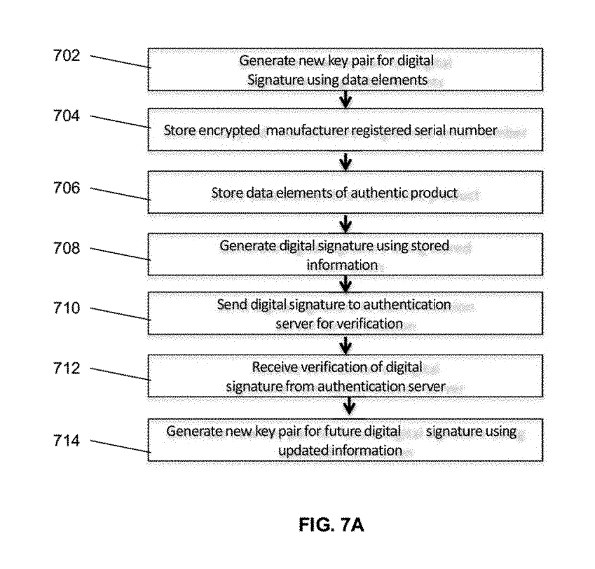

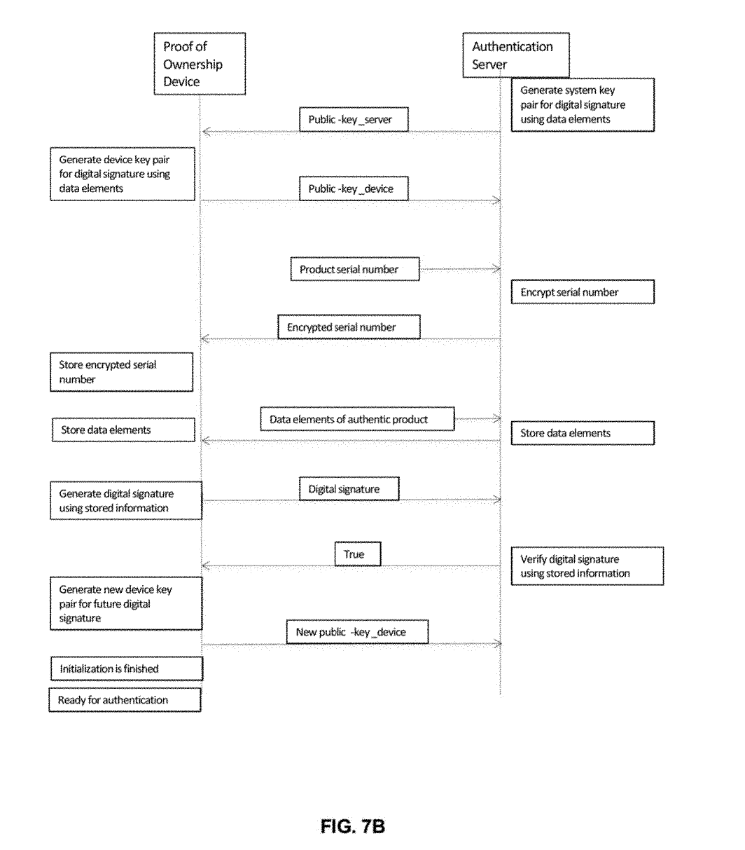

FIG. 7A and FIG. 7B illustrate the method for initializing the proof of ownership device by a server according to aspects of the present disclosure. In some implementations, the initialization process can be performed at a manufacturer site of the proof of ownership device. For security communication, the proof of ownership device and the authentication server generate asymmetric ECC key pairs (public-key device and private-key device, public-key server and private-key server). Public-key server is pre-installed into the proof of ownership device in manufacturing. In some implementations, for key exchange between server and the proof of ownership device, DHKE (Diffie-Hellman Key Exchange) may be applied. The proof of ownership device sends public-key device encrypted by pre-installed public-key to authentication server. To store product serial number into the proof of ownership device, the number is entered via smartphone to server. Server encrypts product serial number and this number is sent to the proof of ownership device and stored to create a genesis data block. Product serial number is one of key elements of genesis block. Other data elements are used to compose of genesis block, such as proof of ownership device ID and initial transaction records can be shared to the proof of ownership device and the authentication server via smartphone. These data elements are stored in the proof of ownership device and the authentication server, block by block. Stored data elements are utilized to generate digital signature as ingredients. Digital signature generated in the proof of ownership device can be sent to the authentication server and verified. In this initialization, it is common for the authentication server to produce a ‘True’ response (which means authentic product), unless the proof of ownership device has an engineering/manufacturing problem. After verification is done, the proof of ownership device generates a new key pair (public-key device and private-key device) to strengthen security. New public-key device concatenated predetermined security code is sent to the authentication server after verification of digital signature. If this security code is not what the authentication server expects, previous verification with old public-key device will be revoked. In the exemplary implementation shown in FIG. 7A, in block 702, the controller of the proof of ownership device generates a new key pair for digital signature using data elements. In block 704, the controller stores encrypted manufacturer registered serial number. In block 706, the controller stores data elements of the authentic product. In block 708, the controller generates digital signature using the stored information. In block 710, the controller sends the digital signature to an authentication server for verification. In block 712, the controller receives a verification of the digital signature from the authentication server. In block 714, the controller generates a new key pair for subsequent/future digital signature using updated information. FIG. 7B illustrates the processes described in FIG. 7A in the form of software flow diagram.

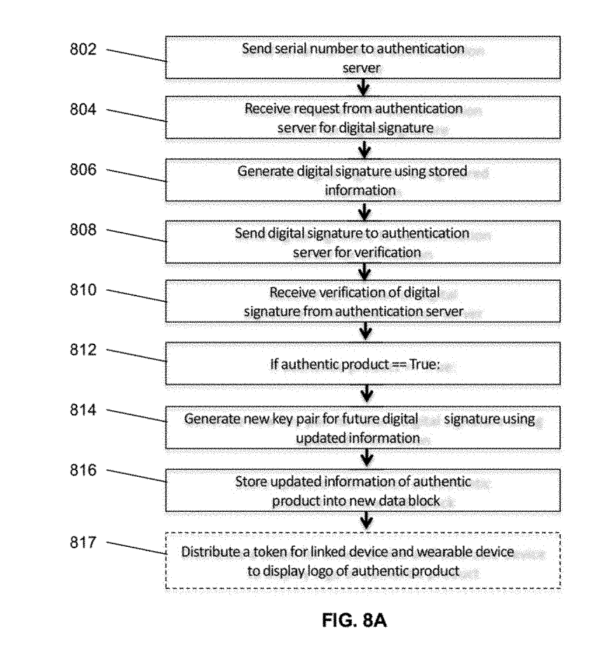

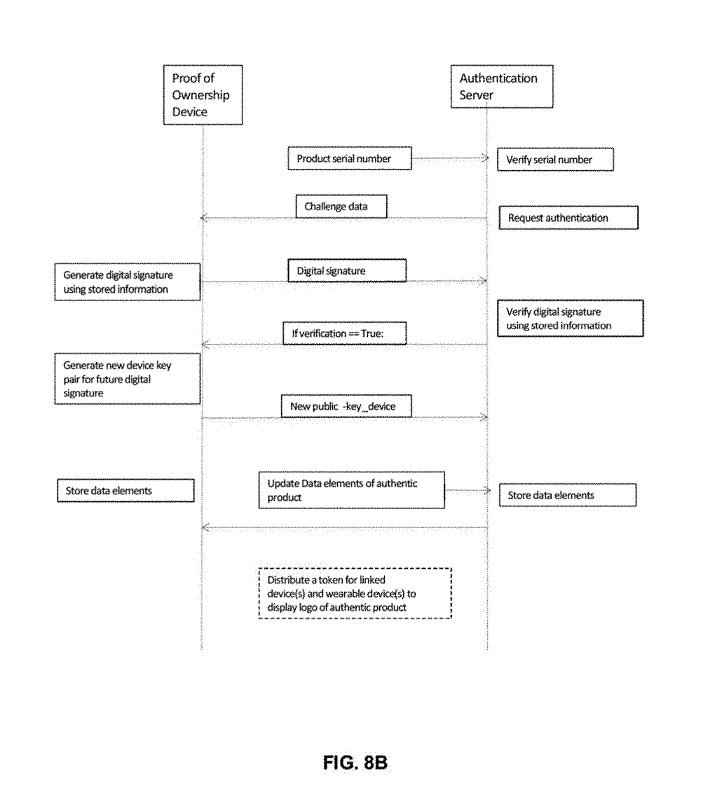

FIG. 8A and FIG. 8B illustrate a method of authenticating the proof of ownership device according to aspects of the present disclosure. As described above in association with FIG. 7, after the proof of ownership device is initialized, it can be used to authenticate the product. To authenticate the product, the owner may be prompted to enter a product serial number to server via smartphone. After the product serial number is entered to the authentication server, the authentication server verifies whether the product serial valid or not. The authentication server may use some questionnaires to verify the validity of the owner. For instance, the authentication server asks questions regarding the latest date of inquiry of authentication, or notify latest history of authentication inquiries. After the product serial number is verified, the authentication server issues an encrypted challenge data, which requests authentication, to the proof of ownership device. The proof of ownership device decrypts this challenge data and utilizes the decrypted challenge data to generate digital signature as one of the data elements (ingredients). A digital signature generated by the proof of ownership device is then sent to the authentication server via smartphone. The authentication server verifies this digital signature to be ‘True’ or ‘False’. If it, is ‘False’, server confirms this result to the proof f ownership device via smartphone and stops the authentication process. If it is ‘True’, server confirms this result to the proof of ownership device via smartphone and the proof of ownership device generates a new key pair for future authentication. New public-key device concatenated predetermined security code is sent to the authentication server. If this security code is not what the authentication server expects, previous verification with old public-key device will be revoked. The authentication server and the proof of ownership device may add new transaction record in the new data block. In addition, the authentication server may issue a token that may enable a wearable device to display a logo or a symbol of the authentic product. This token may be delivered to the wearable device via the smartphone. In the exemplary implementation shown in FIG. 8A, in block 802, the controller of the proof of ownership device sends a serial number to the authentication server. In block 804, the controller receives a request from the authentication server for a digital signature. In block 806, the controller generates a digital signature using stored information. In block 808, the controller sends the digital signature to the authentication server for verification. In block 810, the controller receives verification of the digital signature from the authentication server. In block 812, the controller examines whether a ‘True’ indication is received regarding the authentic product in block 814, the controller generates a new key pair for future digital signature using the updated information in response to the ‘True’ indication is received. In block 816, the controller stores updated information of authentic product into a new data block. In block 817, the controller may optionally distribute a token for linked device and wearable device to display a logo of the authentic product. FIG. 8B illustrates the processes described in. FIG. 8A in the form of software flow diagram.

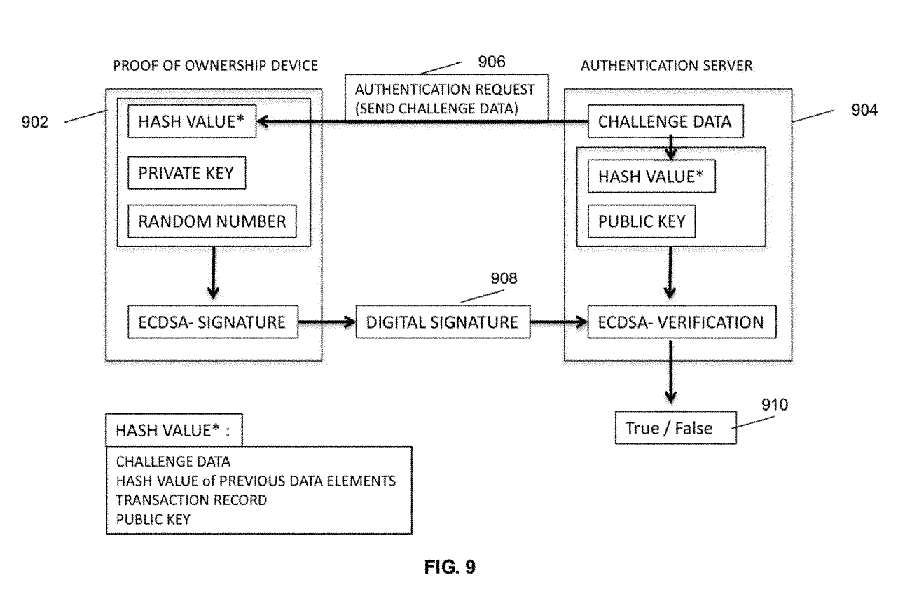

In the example, shown, in FIG. 9, when the proof of ownership device 902 communicates with the authentication server 904 for authentication, the authentication server 904 sends an authentication request 906 to the proof of ownership device 902 by sending random challenge data. The proof of ownership device 902 computes a hash value of this challenge data with other data in the memory to be used to generate digital signature 908. This digital signature 908 is generated with hash value, private-key device and random number in ECDSA engine, and then it is sent to the authentication server 910 for verification. Once the proof of ownership device is verified to be associated with an authentic product, the authentication server 904 distributes a token for linked user device(s) or wearable device(s) to display a logo or a symbol of the authentic product.

In some embodiments, a linked user device, such as a computer, smartphone or tablet, may perform the updating transaction. The linked user device reports new transactions and changes to the authentication server. The proof of ownership device may be connected to the authentication server via the linked user device. A new transaction may trigger generation of a new data block and new key pair for the cryptosystem. The new data block with a new public-key may then be chained with previous data block and stored in the proof of ownership device.

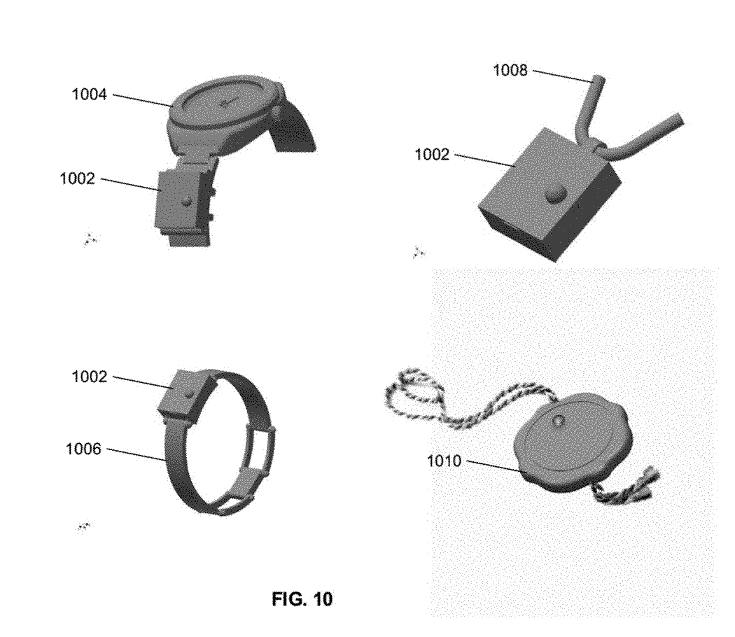

FIG. 10 illustrates exemplary methods of attaching the proof of ownership device to a product according to aspects of the present disclosure. In the examples shown in FIG. 10, the upper left corner shows a sit-on type of attachment, where the proof of ownership device 1002 is on a wristband of a watch 1004.

The lower left corner shows a sit-in type of attachment, where the proof of ownership device 1002 is a part of the wristband 1006. The upper right corner shows a tag type of attachment, where the proof of ownership device 1002 is worn with a necklace 1008. The lower right corner is shown as a separated item, where the proof of ownership device 1010 can be worn as a bracelet.

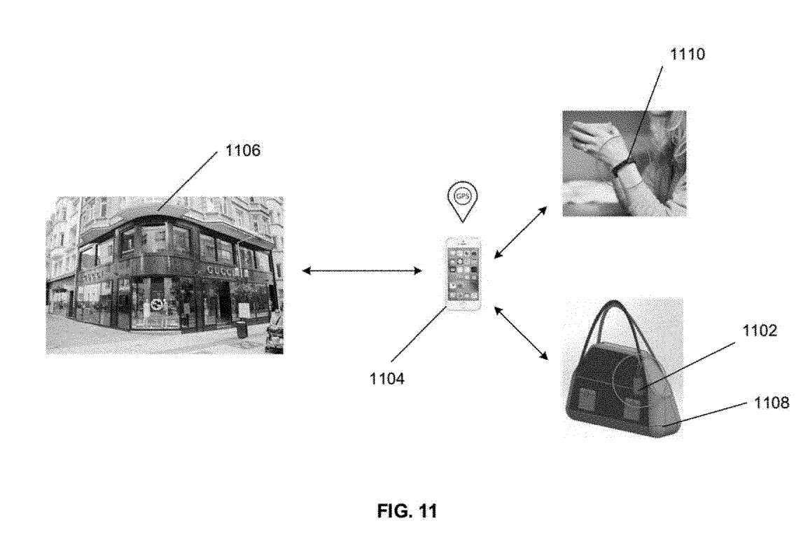

FIG. 11 illustrates an exemplary method of using GPS data to enhance the service of the authentic product according to, aspects of the present disclosure. In the example shown in FIG. 11, the proof of ownership device 1102 may detect its global positioning system location, via a linked device such as a smartphone 1104 or tablet, being near an authorized service center or an authorized retailer 1106. The proof of ownership device 1102 may determine whether the authentic product 1108 may be due for service. The proof of ownership device 1102 may then generate a notification message to the owner of the authentic product in response to a determination that the authentic product 1108 is due for service, for example via the linked device 1104 or a wearable device 1110.

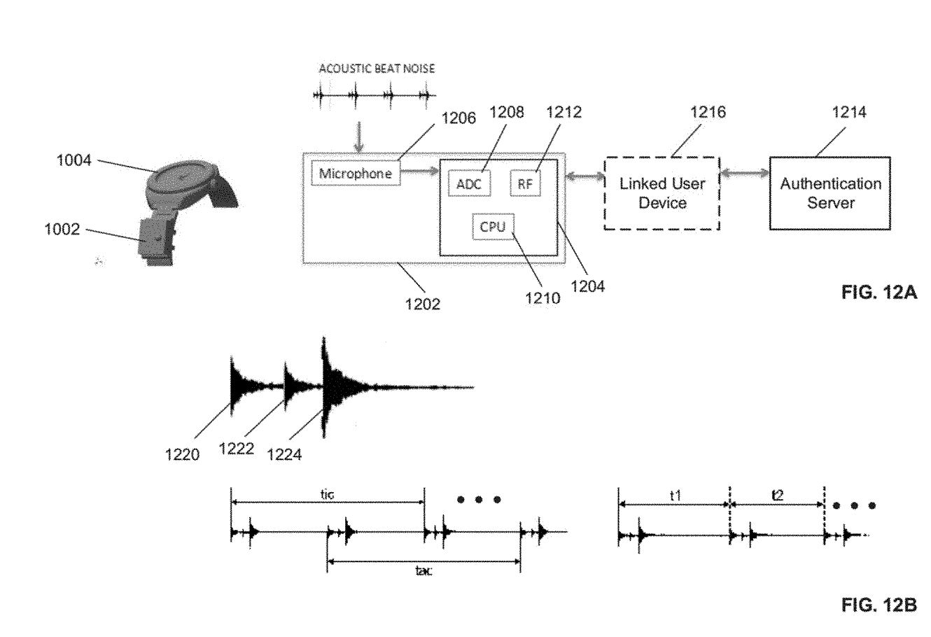

FIG. 12A illustrates an exemplary application of the proof of ownership device according to aspects of the present disclosure. In the exemplary implementation shown in FIG. 12A, the proof of ownership device 1202 may include a controller 1204 and a microphone 1206. The proof of ownership device 1202 may also include other components as described above in association with FIG. 2. The controller 1204 may be configured to control the operations of the proof of ownership device 1202. The microphone 1206 may be configured to record acoustic beat noise emitted from an authentic product. The controller 1204 may include an analog-to-digital converter 1208, a central processing unit or processor 1210, and a radio frequency transceiver 1212. The controller may also include other components as described above in association with FIG. 3. The proof of ownership device 1202 may communicate with an authentication server 1214 as described above in association with FIG. 1A. In other embodiments, the proof of ownership device 1202 may communicate with an authentication server 1214 via an optional linked user device 1216 as described above in association with FIG. 5A through FIG. 5D.

FIG. 12B illustrates exemplary waveforms recorded by the proof of ownership device according to aspects of the present disclosure. In some implementations, the proof of ownership device 1202 may be configured to monitor an acoustic beat noise of the authentic product, determine whether the acoustic beat noise of the authentic product is within a specification of the authentic product, and notify an owner of the authentic product to bring the authentic product for service in response to the acoustic beat noise of the authentic product falls outside the manufacturer specification.

As shown in FIG. 12B, the proof of ownership device may be configured to monitor a waveform of acoustic beat noise by an authentic product, such as a mechanical watch. For example, the acoustic noise of the lever escapement in the watch movement may comprise three different pulses (or noises). A first noise 1220 may be temporally very precise and may be there for used for the graph recording and for calculation of the rate deviation and the beat error. A second noise 1222 may be an irregular noise which cannot be used for evaluation. The third noise 1224 has larger amplitude than the first noise 1220 and the second noise 1222; and the third noise 1224 is evaluated for the calculation of the amplitude The proof of ownership device 1202 may be configured to acquire and analyze the noises to find unique patterns, such as beat rate deviation, beat error, frequency of the balance wheel, etc. This information may then be used for identifying and authenticating the authentic watch like a human fingerprint. The beat rate and beat error may be calculated by following expressions: Beat Rate=(tic+tac)/2 and Beat error=(t1−t2)/2.

In some implementations, the proof of ownership device 1202 may transmit the acquired acoustic beat noise data to the linked user device 1216, such as a computer or smartphone, for real time spectrum analysis using Fast Fourier Transform and octave band filter. This analysis data may be displayed at the linked user device 1216, and may be saved to the proof of ownership device 1202 and the authentication server 1214. For the analysis, a specified beat noise frequency may be set as a preference parameter to the linked user device. This specified frequency can be obtained from watch manufactures on the product specification.

According to aspects of the present disclosure, the proof of ownership device may comprise a wireless transceiver that is capable of transmitting and receiving wireless signals via wireless antenna over a wireless communication network. Wireless transceiver may be connected to a bus by a wireless transceiver bus interface. The wireless transceiver bus interface may, in some embodiments be at least partially integrated with wireless transceiver. Some embodiments may include multiple wireless transceivers and wireless antennas to enable transmitting and/or receiving signals according to a corresponding multiple wireless communication standards.

In addition, the proof of ownership device may comprise digital signal processor(s) (DSP(s)) connected to the bus by a bus interface, processor(s) connected to the bus by a bus interface and memory. The bus interface may be integrated with the DSP(s), processor(s) and memory. In various embodiments, functions may be performed in response execution of one or more machine-readable instructions stored in memory such as on a computer-readable storage medium, such as RAM, ROM, FLASH, or disc drive, just to name a few example. The one or more instructions may be executable by processor(s), specialized processors, or DSP(s). The memory may comprise a non-transitory processor-readable memory and/or a computer-readable memory that stores software code (programming code, instructions, etc.) that are executable by processor(s) and/or DSP(s) to perform functions described herein

According to aspects of the present disclosure, a user interface of the proof of ownership device may comprise any one of several devices such as, for example, a speaker, microphone, display device, vibration device, etc. In a particular implementation, the user interface may enable a user to interact with one or more applications hosted on the proof of ownership device. For example, devices of user interface may store analog or digital signals on the memory to be further processed by DSP(s) or processor in response to action from a user. Similarly, applications hosted on the proof of ownership device may store analog or digital signals on the memory to present an output signal to a user. In another implementation, the proof of ownership device may optionally include a dedicated audio input/output (I/O) device comprising, for example, a dedicated speaker, microphone, digital to analog circuitry, analog to digital circuitry, amplifiers and/or gain control. In another implementation, the proof of ownership device may comprise touch sensors responsive to touching or pressure on a surface of the proof of ownership device.

The proof of ownership device may also comprise a dedicated camera device for capturing still or moving imagery. The dedicated camera device may comprise, for example an imaging sensor (e.g., charge coupled device or CMOS imager), lens, analog to digital circuitry, frame buffers, etc. In one implementation, additional processing, conditioning, encoding or compression of signals representing captured images may be performed at the processor(s) or DSP(s). Alternatively, a dedicated video processor may perform conditioning, encoding, compression or manipulation of signals representing captured images. Additionally, the dedicated video processor may decode/decompress stored image data for presentation on a display device on the proof of ownership device.

The proof of ownership device may also comprise sensors coupled to the bus which may include, for example, inertial sensors and environment sensors. Inertial sensors may comprise, for example accelerometers (e.g., collectively responding to acceleration of the proof of ownership device in three dimensions), one or more gyroscopes or one or more magnetometers (e.g., to support one or more compass applications). Environment sensors of the proof of ownership device may comprise, for example, temperature sensors, barometric pressure sensors, ambient light sensors, and camera imagers, microphones, just to name few examples. The sensors may generate analog or digital signals that may be stored in memory and processed by DPS(s) or processor(s) in support of one or more applications such as, for example, applications directed to positioning or navigation operations.

It will be appreciated that the above descriptions for clarity have described embodiments of the invention with reference to different functional units and processors. However, it will be apparent that any suitable distribution of functionality between different, functional units or processors may be used without detracting from the invention. For example, functionality illustrated to be performed by separate processors or controllers may be performed by the same processors or controllers. Hence, references to specific functional units are to be seen as references to suitable means for providing the described functionality rather than indicative of a strict logical or physical structure or organization.

The invention can be implemented in any suitable form, including hardware, software, firmware, or any combination of these. The invention may optionally be implemented partly as computer software running on one or more data processors and/or digital signal processors. The elements and components of an embodiment of the invention may be physically, functionally, and logically implemented in any suitable way, indeed, the functionality may be implemented in a single unit, in a plurality of units, or as part of other functional units. As such, the invention may be implemented in a single unit or may be physically and functionally distributed between different units and processors.

One skilled in the relevant art will recognize that many possible modifications and combinations of the disclosed embodiments may be used, while still employing the same basic underlying mechanisms and methodologies. The foregoing description, for purposes of explanation, has been written with references to specific embodiments. However, the illustrative discussions above are not intended to be exhaustive or to limit the invention to the precise forms disclosed. Many modifications and variations are possible in view of the above teachings. The embodiments were chosen and described to explain the principles of the invention and their practical applications, and to enable others skilled in the art to best utilize the invention and various embodiments with various modifications as suited to the particular use contemplated.

What is claimed is:

1. A proof of ownership device, comprising:
a transceiver configured to wirelessly communicate with an authentication server;
a memory configured to store information about an authentic product made by a manufacturer;
a battery configured to provide power to the proof of ownership device; and
a controller configured to pair the proof of ownership device to the authentic product and control a status update of the authentic product.

2. The proof of ownership device of claim 1, further comprising:
a LED configured to indicate a status of the proof of ownership device; and
a power management circuit configured to control power usage of the proof of ownership device.

3. The proof of ownership device of claim 1, further comprising:
a USB interface configured to communicate with a linked user device or configured to charge the battery.

4. The proof of ownership device of claim 1, wherein the controller comprises:
an encryption engine configured to encrypt an encrypted serial number and information of the authentic product;
a plurality of I/O interfaces configured to communicate with peripherals;
a radio frequency controller configured to control communication With the authentication server via a linked user device or via the proof of ownership device wirelessly; and
a processor configured to control operations of the proof of ownership device.

5. The proof of ownership device of claim 4, wherein the encryption engine comprises:
a secured hash engine configured to generate a hash value based on the inputs received from data elements stored in the memory, a public key stored in the memory, and challenge data sent by the authentication server; and
a digital signature engine configured to generate a digital signature based on the inputs received from the secure hash engine, a private key stored in the memory, and a random number.

6. The proof of ownership device of claim 1,
wherein the transceiver is configured to wirelessly communicate with the authentication server via a linked user device, wherein the linked user device comprises at least one of: a smartphone, a tablet, or a personal computer.

7. The proof of ownership device of claim 6, wherein the transceiver is father configured to receive input data encrypted by the authentication server via the linked user device.

8. The proof of ownership device of claim 1, wherein the memory is configured to store:
public keys;
private keys;
public key certificates;
an encrypted serial number of the authentic product;
identification number of the proof of ownership device;
challenge data; and
transaction records of the authentic product.

9. The proof of ownership device of claim 8,
wherein the transaction records comprise a series of chained records showing events of prior activities related to the authentic product.

10. The proof of ownership device of claim 9, wherein each chained record in the series of chained records further comprises a public key that is associated with a private key to be used to generate a digital signature of a subsequent transaction record of the authentic product.

11. The proof of ownership device of claim 1, wherein the controller is further configured to:
receive a request for a digital signature from the authentication server;
generate the digital signature using a current record of the authentic product along with a hash value, a private key, and a random number;
send the digital signature to the authentication server for verification; and
receive a confirmation of the digital signature from the authentication server.

12. The proof of ownership device of claim 11, wherein the controller is further configured to:
issue a new key pair after receiving the confirmation of the digital signature from the authentication server;
send an updated public key to the authentication server via a linked device, wherein if a predetermined security code that is concatenated with the updated public key fails a verification by the authentication server, the authentication server revokes the confirmation of the digital signature.

13. The proof of ownership device of claim 1, wherein the proof of ownership device is in the form of at least one of:
a wearable electronic smart watch, wherein the wearable electronic smart watch is configured to display a logo of the authentic product;
a wearable electronic smart wrist band, wherein the wearable electronic smart wrist band is configured to display the logo of the authentic product;
an electronic device with a display, wherein the electronic device with the display is configured to display the logo of the authentic product; or
an electronic device configured to be physically attachable to a wearable item.

14. The proof of ownership device of claim 11, further comprising.
upon verifying the proof of ownership device is paired with the authentic product, the proof of ownership device is configured to be linked with a wearable device, wherein the wearable device is configured to display a logo of the authentic product.

15. The proof of ownership device of claim 14,
wherein the proof of ownership device is linked with the wearable device via a smartphone, a tablet, computer.

16. The proof of ownership device of claim 1, wherein the controller is further configured to:
detect a global positioning system location of the proof of ownership device being near a manufacture representative, a distributor, or a service center;
determine whether the authentic product is due for service; and
generate a notification message to an owner of the authentic product in response to a determination that the authentic product is due for service.

17. The proof of ownership device claim 13, wherein the proof of ownership device is physically attached to the authentic product, wherein the controller is further configured to:
monitor an acoustic beat noise of the authentic product;
determine whether the acoustic beat noise of the authentic product is within a specification of the authentic product; and
notify an owner of the authentic product to bring the authentic product for service in response to the acoustic beat noise of the authentic product falls outside the manufacturer specification.
